(19) United States
(12) Patent Application Publication
(10) Pub. No.: US 2023/0139912 A1
(43) Pub. Date: May 4, 2023

(54) CHANNEL BUSY MEASUREMENTS IN SIDELINK COMMUNICATIONS

(71) Applicant: QUALCOMM INCORPORATED, San Diego, CA (US)

(72) Inventors: Xiaoxia ZHANG, San Diego, CA (US); Jing SUN, San Diego, CA (US); Chih-Hao LIU, San Diego, CA (US); Yisheng XUE, San Diego, CA (US); Changlong XU, Beijing (CN); Ozcan OZTURK, San Diego, CA (US)

(21) Appl. No.: 17/915,286

(22) PCT Filed: May 29, 2020
(86) PCT No.: PCT/CN2020/093494

§ 371 Date: Sep. 28, 2022

(51) Int. Cl. H04W 74/08; H04W 74/00

(52) U.S. Cl. CPC H04W 74/0816; H04W 74/0866; H04W 74/002

(57) ABSTRACT

Methods, systems, and devices for wireless communications are described. A user equipment (UE) communicating over sidelink in unlicensed spectrum may perform channel congestion control based on channel busy measurements. For example, a UE may perform channel busy measurement over different resource sets to identify congestion levels from different Radio Access Technologies (RATs). The UE may perform a first channel busy measurement on a first resource set where the first resource set contains resources where sidelink UEs are configured to pause transmission and the UE may perform a second channel busy measurement on a second resource set when sidelink UEs and wireless devices of other RATs are free to contend for resources and transmit. The UE may perform third channel busy measurement on a third resource set where the third resource set contains resources with contention-based access success.

### CROSS REFERENCE

The present application is a 371 national stage filing of International PCT Application No. PCT/CN2020/093494 by ZHANG et al. entitled “CHANNEL BUSY MEASUREMENTS IN SIDELINK COMMUNICATIONS,” filed May 29, 2020, which is assigned to the assignee hereof, and which is expressly incorporated by reference in its entirety herein.

### FIELD OF TECHNOLOGY

The following relates generally to wireless communications and more specifically to channel busy measurements in sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, two or more devices may attempt sidelink communications in an unlicensed spectrum. Sidelink communications may use channel busy measurements, such as a Channel Busy Ratio (CBR), as a metric for congestion control. When operating in the unlicensed spectrum, channel busy measurement may measure components from other Radio Access Technologies (RATs), such as Wi-Fi, in addition to the components from sidelink UE signals. As a result, relying on a channel busy measurement performed in this manner may not accurately represent the sidelink traffic congestion and may therefore result in inaccurate sidelink congestion control in unlicensed spectrum.

### SUMMARY

The described techniques relate to improved methods, systems, devices, and apparatuses that support channel busy measurements in sidelink communications. Generally, the described techniques enable a user equipment (UE) communicating over sidelink in unlicensed spectrum to perform channel congestion control by performing channel busy measurement over different resource sets to identify congestion levels from different Radio Access Technologies (RATs). For example, a first UE may perform a first channel busy measurement on a first resource set where the first resource set contains resources where Sidelink UEs are configured to pause transmission. The first UE may perform a second channel busy measurement on a second resource set when sidelink UEs and wireless devices of other RATs are free to contend for resources and transmit. The first UE may perform a third channel busy measurement on a third resource set where the third resource set contains resources with contention-based access success. The first UE may configure communication parameters for congestion control based at least in part on the first channel busy measurement, the second channel busy measurement, and the third channel busy measurement, individually or in combination.

A method of wireless communications at a first UE is described. The method may include identifying a set of resources of an unlicensed radio frequency spectrum band, the set of resources configured for channel busy measurements that are free from sidelink traffic, pausing sidelink transmissions during the identified resource set, performing, while pausing sidelink transmissions, a channel busy measurement for the set of resources, and communicating with a second UE via a channel of the unlicensed radio frequency spectrum band based on the channel busy measurement.

An apparatus for wireless communications at a first UE is described. The apparatus may include a processor, memory coupled with the processor, and instructions stored in the memory. The instructions may be executable by the processor to cause the apparatus to identify a set of resources of an unlicensed radio frequency spectrum band, the set of resources configured for channel busy measurements that are free from sidelink traffic, pause sidelink transmissions during the identified resource set, perform, while pausing sidelink transmissions, a channel busy measurement for the set of resources, and communicate with a second UE via a channel of the unlicensed radio frequency spectrum band based on the channel busy measurement.

Another apparatus for wireless communications at a first UE is described. The apparatus may include means for identifying a set of resources of an unlicensed radio frequency spectrum band, the set of resources configured for channel busy measurements that are free from sidelink traffic, pausing sidelink transmissions during the identified resource set, performing, while pausing sidelink transmissions, a channel busy measurement for the set of resources, and communicating with a second UE via a channel of the unlicensed radio frequency spectrum band based on the channel busy measurement.

A non-transitory computer-readable medium storing code for wireless communications at a first UE is described. The code may include instructions executable by a processor to identify a set of resources of an unlicensed radio frequency spectrum band, the set of resources configured for channel busy measurements that are free from sidelink traffic, pause sidelink transmissions during the identified resource set, perform, while pausing sidelink transmissions, a channel busy measurement for the set of resources, and communicate with a second UE via a channel of the unlicensed radio frequency spectrum band based on the channel busy measurement.

Some examples of the method, apparatuses, and non-transitory computer-readable medium described herein may further include operations, features, means, or instructions for selecting the channel of the unlicensed radio frequency spectrum band for communicating with the second UE based on determining that a congestion level of the channel satisfies a congestion threshold.

Some examples of the method, apparatuses, and non-transitory computer-readable medium described herein may further include operations, features, means, or instructions for selecting the channel of the unlicensed radio frequency spectrum band for communicating a sidelink message with the second UE based on determining that a priority of the sidelink message satisfies a priority threshold.

Some examples of the method, apparatuses, and non-transitory computer-readable medium described herein may further include operations, features, means, or instructions for selecting the channel of the unlicensed radio frequency spectrum band for communicating with the second UE independent of a congestion level of the channel satisfying a congestion threshold.

In some examples of the method, apparatuses, and non-transitory computer-readable medium described herein, the priority threshold corresponds to a service type of the sidelink message.

In some examples of the method, apparatuses, and non-transitory computer-readable medium described herein, performing the channel busy measurement may include operations, features, means, or instructions for determining a measurement window configured for measurements that may be free from sidelink traffic, and measuring one or more channel parameters over the measurement window and the set of resources.

In some examples of the method, apparatuses, and non-transitory computer-readable medium described herein, the one or more channel parameters include received signal strength indicator (RSSI), reference signal received power (RSRP), reference signal received quality (RSRQ), signal to interference plus noise ratio (SINR), or any combination thereof.

Some examples of the method, apparatuses, and non-transitory computer-readable medium described herein may further include operations, features, means, or instructions for determining an active bandwidth part for sidelink communications between the UE and the second UE, and performing the channel busy measurement on at least one subcarrier excluded from the active bandwidth part.

Some examples of the method, apparatuses, and non-transitory computer-readable medium described herein may further include operations, features, means, or instructions for determining a second set of resources of the unlicensed radio frequency spectrum band, the second set of resources configured for channel busy measurements that may be associated with sidelink traffic, performing a second channel busy measurement for the second set of resources, and selecting the channel of the unlicensed radio frequency spectrum band for communicating with the second UE based on the second channel busy measurement.

In some examples of the method, apparatuses, and non-transitory computer-readable medium described herein, performing the second channel busy measurement may include operations, features, means, or instructions for performing the second channel busy measurement on resources of the second set of resources that may be non-overlapping with the set of resources.

Some examples of the method, apparatuses, and non-transitory computer-readable medium described herein may further include operations, features, means, or instructions for determining a set of communication parameters for sidelink communications based on the channel busy measurement and the second channel busy measurement, and communicating with the second UE using the set of communication parameters.

In some examples of the method, apparatuses, and non-transitory computer-readable medium described herein, determining the set of communication parameters may include operations, features, means, or instructions for determining a difference between the channel busy measurement and the second channel busy measurement, and selecting the set of communication parameters based on the difference.

In some examples of the method, apparatuses, and non-transitory computer-readable medium described herein, the set of communication parameters includes a modulation and coding scheme (MCS), a transmit power, a number of retransmissions, a number of sub-channels, a coding rate, or any combination thereof.

A method of wireless communications at a first UE is described. The method may include monitoring each of a set of resources of an unlicensed radio frequency spectrum band associated with sidelink communications, determining one or more resources of the set of resources for channel busy measurements, where each of the one or more resources correspond to a successful contention-based access procedure based on the monitoring, performing a channel busy measurement for each of the one or more resources, and communicating with a second UE via a channel of the unlicensed radio frequency spectrum band based on the channel busy measurement.

An apparatus for wireless communications at a first UE is described. The apparatus may include a processor, memory coupled with the processor, and instructions stored in the memory. The instructions may be executable by the processor to cause the apparatus to monitor each of a set of resources of an unlicensed radio frequency spectrum band associated with sidelink communications, determine one or more resources of the set of resources for channel busy measurements, where each of the one or more resources correspond to a successful contention-based access procedure based on the monitoring, perform a channel busy measurement for each of the one or more resources, and communicate with a second UE via a channel of the unlicensed radio frequency spectrum band based on the channel busy measurement.

Another apparatus for wireless communications at a first UE is described. The apparatus may include means for monitoring each of a set of resources of an unlicensed radio frequency spectrum band associated with sidelink communications, determining one or more resources of the set of resources for channel busy measurements, where each of the one or more resources correspond to a successful contention-based access procedure based on the monitoring, performing a channel busy measurement for each of the one or more resources, and communicating with a second UE via a channel of the unlicensed radio frequency spectrum band based on the channel busy measurement.

A non-transitory computer-readable medium storing code for wireless communications at a first UE is described. The code may include instructions executable by a processor to monitor each of a set of resources of an unlicensed radio frequency spectrum band associated with sidelink communications, determine one or more resources of the set of resources for channel busy measurements, where each of the one or more resources correspond to a successful contention-based access procedure based on the monitoring, perform a channel busy measurement for each of the one or more resources, and communicate with a second UE via a channel of the unlicensed radio frequency spectrum band based on the channel busy measurement.

Some examples of the method, apparatuses, and non-transitory computer-readable medium described herein may further include operations, features, means, or instructions for detecting sidelink control information in each of the one or more resources based on the monitoring, where the one or more resources of the set of resources may be determined based on detecting the sidelink control information.

In some examples of the method, apparatuses, and non-transitory computer-readable medium described herein, the sidelink control information may be associated with a transmitting UE different from the first UE.

Some examples of the method, apparatuses, and non-transitory computer-readable medium described herein may further include operations, features, means, or instructions for determining a window that spans the set of resources of the unlicensed radio frequency spectrum band associated with sidelink communications, where the channel busy measurement may be performed for each of the one or more resources within the window.

In some examples of the method, apparatuses, and non-transitory computer-readable medium described herein, the window corresponds to a number of the set of resources.

In some examples of the method, apparatuses, and non-transitory computer-readable medium described herein, the window corresponds to a number of the one or more resources.

Some examples of the method, apparatuses, and non-transitory computer-readable medium described herein may further include operations, features, means, or instructions for performing channel sensing in each of the set of resources based on the monitoring, where the one or more resources of the set of resources may be determined based on successful channel sensing.

### BRIEF DESCRIPTION OF THE DRAWINGS

FIG. 1 illustrates an example of a wireless communications system that supports channel busy measurements in sidelink communications in accordance with aspects of the present disclosure.

FIG. 2 illustrates an example of a wireless communications system that supports channel busy measurements in sidelink communications in accordance with aspects of the present disclosure.

FIG. 3 illustrates an example of a wireless communication channel that supports channel busy measurements in sidelink communications in accordance with aspects of the present disclosure.

FIG. 4 illustrates an example of a wireless communication channel that supports channel busy measurements in sidelink communications in accordance with aspects of the present disclosure.

FIG. 5 illustrates an example of a process flow that supports channel busy measurements in sidelink communications in accordance with aspects of the present disclosure.

FIG. 6 illustrates an example of a process flow that supports channel busy measurements in sidelink communications in accordance with aspects of the present disclosure.

FIGS. 7 and 8 show block diagrams of devices that support channel busy measurements in sidelink communications in accordance with aspects of the present disclosure.

FIG. 9 shows a block diagram of a communications manager that supports channel busy measurements in sidelink communications in accordance with aspects of the present disclosure.

FIG. 10 shows a diagram of a system including a device that supports channel busy measurements in sidelink communications in accordance with aspects of the present disclosure.

FIGS. 11 through 17 show flowcharts illustrating methods that support channel busy measurements in sidelink communications in accordance with aspects of the present disclosure.

### DETAILED DESCRIPTION

In some wireless communications systems, two or more devices may attempt sidelink communications in an unlicensed spectrum. Sidelink communications may be subject to performance degradation under increased channel load and a user equipment (UE) may use congestion control mechanisms to mitigate collisions. Congestion control mechanisms may configure one or more transmission parameters such as Modulation and Coding Scheme (MCS) indices and MCS tables, number of sub-channels per transmission, number of retransmissions, transmission power, and channel occupancy ratio limit.

Sidelink communications may use a channel busy measurements, such as a Channel Busy Ratio (CBR), as a metric for congestion control. Channel busy measurements may be performed by measuring the channel congestion level over a set of resources proceeding the measurement. Channel busy measurements may be based on Received Signal Strength Indicator (RSSI) measured on a given channel (e.g., a sidelink channel).

When operating in the unlicensed spectrum, a channel busy measurement may include signal components from other Radio Access Technologies (RATs) communications, such as Wi-Fi communications, in addition to the signals components from sidelink UE components within a coverage area. As a result, relying on channel busy measurements performed in this manner may not accurately represent the sidelink traffic congestion and may therefore result in inaccurate sidelink congestion control in unlicensed spectrum.

A UE may perform additional channel busy measurements on different resource sets to differentiate congestion levels from sidelink UEs and other RATs. The additional sidelink channel busy measurements may include measuring different RSSI measurement resources, reports, and thresholds. The additional channel busy measurements may be used alone or in combination to inform congestion control.

A first channel busy measurement may measure the congestion level from wireless devices operating with other RATs, such as Wi-Fi. The first channel busy measurement may be performed on a first resource set composed of resources when sidelink UEs are not transmitting. The measurement window for the first resource set may be configured for the UE to perform channel busy measurements when sidelink UEs are not transmitting. Additionally, the first resource set may include multiple Listen Before Talk (LBT) sub-bands, carriers, and channels beyond the ones included in the active sidelink bandwidth part.

A second channel busy measurement may be performed to estimate the total congestion on a channel from sidelink UEs and from wireless devices operating with other RATs, such as Wi-Fi. The second channel busy measurement may be performed on a second resource set composed of resources when sidelink UEs and other RATs devices are free to contend and transmit signals. The second channel busy measurement may capture the intra-sidelink UE interference in addition to the interference from other RATs, including Wi-Fi. In some examples, the second resource set may include a fixed number of resources that proceed the measurement slot. In some examples, the second resource set may be a sliding window with a fixed duration of resources (i.e., 100 ms) that proceed a channel busy measurement. In some examples, the second resource set may be a fixed number of resources (i.e., 100 slots) that proceed a channel busy measurement. In some examples, the second resource set may include or overlap with resources included in the first resource set. In some examples, the second resource set may exclude the resources included in the first resource set.

A third channel busy measurement may be performed on resources with indication of contention-based access success. In some cases, measuring channel busy measurements over resources with indication of contention-based access success may provide indication of channel congestion in resources that sidelink UEs are not blocked by wireless devices operating with other RATs, such as Wi-Fi. In some cases, the third channel busy measurement may measure congestion from sidelink UEs. In some cases, the third channel busy measurement may measure the channel congestion in resources that sidelink UEs win contention-based access. In some cases, a UE may perform contention-based access procedures to determine resource with contention-based access success. In some cases, a UE may determine contention-based access success by detecting indication of contention-based access success of other sidelink UEs. In some cases, contention-based access success may be determined based on detection of Sidelink Control Information (SCI). For the third channel busy measurement, the UE may consider the resources with at least one SCI detection for measurement. In some cases, if a UE does not decode any SCI from any transmitting UEs for a given resource, then the UE may omit that resource for the third channel busy measurement. In some cases, the first channel busy measurement may be used to determine the inter-RAT congestion. If the first channel busy measurement indicates that the channel is congested, the UE may switch to a different LBT sub-band, carrier, or channel. The determination to switch to a different LBT sub-band, carrier, or channel may be based in part by on the first channel busy measurement satisfying a threshold. The threshold for a UE to switch to a different LBT sub-band, carrier, or channel may depend on the service priority of the UE. The service priority of the device may device dependent. The service priority of a device may be dynamically assigned, semi-dynamically assigned, or permanently assigned. Additionally or alternatively, the threshold for a UE to switch to a different LBT sub-band, carrier, or channel may depend on the service priority of the communication traffic. For example, A UE may use a lower channel busy measurement threshold for high priority traffic and a high channel busy measurement threshold for low priority traffic.

In some examples, the first channel busy measurement may be used in conjunction with the second channel busy measurement to inform congestion control. A network may configure or a UE may determine the congestion control mechanisms, such as but not limited to MCS limits, transmission power limit, number of retransmission limit, number of sub-channels per transmission, and channel occupancy ratio limit, based on both the first and the second channel busy measurement. For example, when the first channel busy measurement is low, the second channel busy measurement may accurately reflect the intra-operator sidelink UE congestion. In this case, the congestion control mechanisms may be satisfactorily configured or determined based solely on the second channel busy measurement. In other examples, when the first channel busy measurement is high, then the channel may be loaded in general and the congestion may not be due to sidelink UE communications. In this case, congestion control based solely on the second channel busy measurement may not be accurate, and it may be beneficial to use the first channel busy measurement and the second channel busy measurement in combination to inform congestion control. Additionally or alternatively, the UE may perform congestion control based on the third channel busy measurement, individually or in combination. Further, the first channel busy measurement, second channel busy measurement, and third channel busy measurement may be used individually or in combination for congestion control.

Aspects of the disclosure are initially described in the context of wireless communications systems. Aspects of the disclosure are further disclosed in the context of communication channels and process flows. Aspects of the disclosure are further illustrated by and described with reference to apparatus diagrams, system diagrams, and flowcharts that relate to channel busy measurements in sidelink communications.

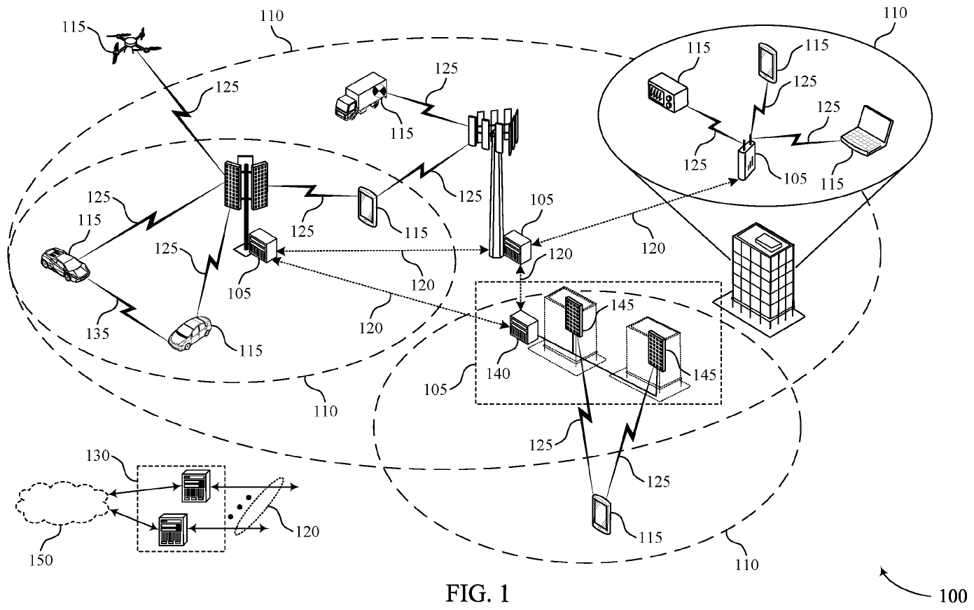

FIG. 1 illustrates an example of a wireless communications system 100 that supports channel busy measurements in sidelink communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may perform additional channel busy measurements on different resource sets to differentiate congestion levels from sidelink UEs 115 and congestion levels from other RATs. The additional measurements may include different RSSI measurement resources, reports, and thresholds. A first additional channel busy measurement may be made when sidelink UEs within the network are not transmitting. This channel busy measurement may measure interference from other RATs, such as Wi-Fi. A second channel busy measurement may be made when sidelink UEs are free to contend and transmit sidelink signals for other sidelink UEs 115 to measure. The second channel busy measurement may capture the interference from sidelink UEs 115 and the interference from other RATs, including Wi-Fi. A third channel busy measurement may be contention-based access aware, where the channel busy measurement is measured within the resources with indication of contention-based access success.

The first channel busy measurement, second channel busy measurement, and third channel busy measurement may be used alone or in combination for congestion control. Based on these channel busy measurements, a UE 115 may determine communication parameters such as MCS, transmit power, etc. for sidelink communications. For example, if the first channel busy measurement is low, then the second channel busy measurement may accurately reflect the channel congestion from UE 115 communications. In this case, congestion control may be satisfactorily performed based on the second channel busy measurement. Alternatively, if the first channel busy measurement is high, then the channel may be loaded in general and may not be solely due to UE 115 communications. In this case, congestion control based solely on the second channel busy may not be accurate.

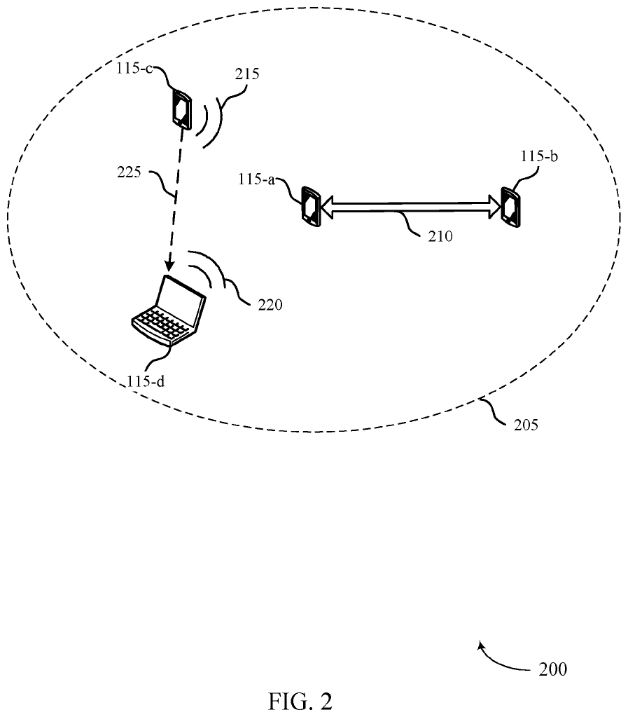

FIG. 2 illustrates an example of a wireless communications system 200 that supports channel busy measurements in sidelink communications in accordance with aspects of the present disclosure. In some examples, wireless communications system 200 may implement aspects of wireless communications system 100. Wireless communications system 200 may include UE 115-a, UE 115-b, UE 115-c, and UE 115 d, which may be examples of corresponding UEs 115 as described with reference to FIG. 1.

UE 115-a may attempt to establish communication link 210 over sidelink channels with UE 115-b, in an unlicensed spectrum. For communication over sidelink channels, UE 115-a may compete for sidelink resources with other UEs 115 in the coverage area 205, such as UE 115-c. UE 115-c may transmit a sidelink transmission 215 in an unlicensed spectrum. For communication over sidelink channels in an unlicensed spectrum, UE 115-a may also compete with wireless devices that operate with different RATs, such as Wi-Fi UE 115-d. Wi-Fi UE 115-d may transmit a Wi-Fi transmission 220. Sidelink transmission 215 and Wi-Fi transmission 220 may cause channel congestion or interference in coverage area 205.

For operation in unlicensed radio frequency spectrum, UE 115-a may perform interference management procedures to determine if a channel is available for use. For example, UE 115-a may perform a channel access procedure. The channel access procedure may be a contention-based access procedure. In some cases, the channel access procedure may be a listen-before-talk (LBT) procedure, or a clear channel assessment (CCA), and the like. UE 115-a may monitor the channel for a time period to determine whether the channel is occupied or available for use. UE 115-a may monitor the channel for energy and or waveforms to determine if the channel is available for use. UE 115-a perform interference management procedures if the channel access procedure determines that sidelink transmission 215 or Wi-Fi transmission 220 occupy the monitored channel.

Additionally or alternatively, UE 115-a may perform congestion control to coordinate the usage of a channel. Congestion control may configure a set of communication parameters to control the congestion level on the channel. The communication parameters that may be configured include but are not limited to MCS indices and MCS tables, number of sub-channels per transmission, number of retransmissions, transmission power, and channel occupancy ratio limit, a coding rate, or any combination thereof.

UE 115-a may use channel busy measurements as a metric for congestion control. UE 115-a may determine if the congestion level of a channel satisfies a congestion threshold base at least in part on channel busy measurements. Channel busy measurements may include or be base on, but are not limited to CBR, RSSI, Reference Signal Received Power (RSRP), Reference Signal Received Quality (RSRQ), Signal to Interference Plus Noise Ratio (SINR), or any combination thereof.

In some examples, UE 115-a may perform a first channel busy measurement to inform congestion control functionality. UE 115-a may perform the first channel busy measurement to measure the channel congestion from signals from devices operating with other RATs, such as Wi-Fi transmission 220 from Wi-Fi UE 115-d. UE 115-a may perform a first channel busy measurement when UEs 115 are not transmitting. This first channel busy measurement may be performed on the first set of measurement resources. The first set of measurement resources may be defined such that UEs 115 may be pre-configured to not transmit during resources associated with the first set of measurement resources. UEs 115-a, 115-b, and 115-c may pause transmission during a first set of measurement resources. UE 115-a may be pre-configured to perform the first channel busy measurement on resources associated with the first set of measurement resources.

In some examples, UE 115-a may perform a second channel busy measurement to inform congestion control functionality. UE 115-a may perform the second congestion control measurement to measure the total channel congestion from devices operating with coverage area 205. For example, the second channel busy measurement may determine the channel congestion from UE 115-c and Wi-Fi UE 115-d. UE 115-a may perform the second channel busy measurement on a second set of measurement resources. The second set of measurement resources may include resource where UE 115-c and Wi-Fi UE 115-d are free to contend for resources and transmit signals. The second set of measurement resources may be a fix number of resources proceeding the measurement. For example, the second set of measurement resources may be sensed over the 100 slots proceeding the measurement. In some cases, the second set of measurement resources may be a sliding measurement window. In some cases, the second set of measurement resources may include the resources included in the first set of measurement resources. In some cases, the second set of measurement resources may exclude resources included in the first set of measurement resources.

In some examples, UE 115-a may perform a third channel busy measurement to inform congestion control functionality. The third channel busy measurement may measure channel congestion in resource with indication of contention-based access success. UE 115-a may determine if a first resource has contention-based access success by either passing medium sensing with clear channel assessment (CCA) or extended CCA (eCCA), or by monitoring for the presence of SCI information from one or more other UEs 115, such as UE 115-c. In some cases, if UE 115-a detects SCI in the first resource, then UE 115-a may determine to perform channel busy measurements on the first resource. In some cases, UE 115-a may include the first resource in a third resource set. If UE 115-a does not detect SCI in a second resource and additionally does not pass CCA/eCCA, then UE 115-a may determine to not perform channel busy measurements on the second resource. In some cases, UE 115-a may determine to exclude the second resource from a third resource set. If UE 115-a does not detect SCI in a third resource but passes CCA/eCCA, then UE 115-a may determine to perform channel busy measurements on the third resource. In some cases, UE 115-a may include the third resource in a third resource set. In some examples, UE 115-a may perform channel busy measurements on resources with indication of contention-based access success inside a measurement window. In some examples, UE 115-a may perform channel busy measurements on the resources included in the third resource set within a measurement window. For example, UE 115-a may perform channel busy measurements on the resources with indication of contention-based access success within the 100 or 100×2^{μ} slots proceeding the measurement. In some examples, UE 115-a may perform channel busy measurements on a fixed number of resources with contention-based access success that proceed the measurement. For example, UE 115-a may perform channel busy measurements on the 100 or 100×2^{μ} slots with indication of contention-based access success proceeding the measurement.

In some examples, UE 115-a may use one or more of the first channel busy measurement, the second channel busy measurement, and the third channel busy measurement separately or in combination to inform channel congestion control functionality. In some examples, UE 115-a may be configured to determine communication parameters for congestion control based solely on the performance of the first channel busy measurement, second channel busy measurement, or third channel busy measurement. In some examples, UE 115-a may determine communication parameters for congestion control based on a combination of at least two of the first channel buys measurement, second channel busy measurement, and third channel busy measurement. For example, UE 115-a may perform the first channel busy measurement and the second channel busy measurement and configure channel communication parameters for congestion control based on the measurements. In some examples, UE 115-a may determine to perform one or more of first channel busy measurement, second channel busy measurement, or third channel busy measurement based one or more indications of the channel congestion. For example, if UE 115-a does not detect enough resources within a measurement window with indication of contention-based access success to satisfy a threshold, then the UE may perform at least one of the first channel busy measurement and the second channel busy measurement to inform congestion control.

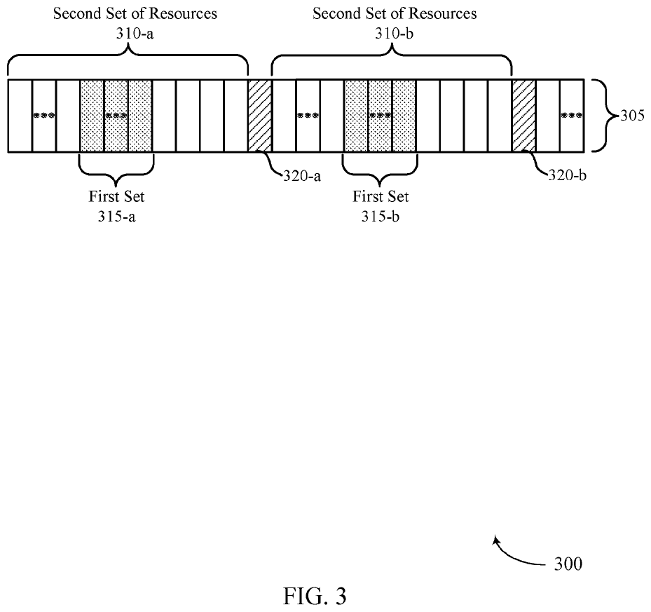

FIG. 3 illustrates an example of a wireless communication channel 300 that supports channel busy measurements in sidelink communications in accordance with aspects of the present disclosure. In some examples, wireless communication channel 300 may be an example of a wireless communication channel implemented in aspects of wireless communications system 100 and wireless communications system 200. Wireless communication channel 300 may be on frequency band 305, which may be a frequency band in the unlicensed radio frequency spectrum. Sidelink UEs 115 may contend with other sidelink UEs 115 and Wi-Fi UEs 115 for resources in frequency band 305. Sidelink UEs 115 may perform congestion control to manage communication traffic on frequency band 305. Sidelink UEs 115 may perform channel busy measurement on frequency band 305 to inform congestion control functions in accordance with aspects of the present disclosure.

A UE 115 may perform channel busy measurements at measurement slot 320-a. UE 115 may perform a first channel busy measurement on a first set of measurement resources 315-a and UE 115 may perform a second channel busy measurement on a second set of measurement resources 310-a.

The first set of measurement resources 315-a may include resources where sidelink UEs 115 are configured to not transmit. The first set of measurement resources 315-a may include resources that include signals from wireless devices operating with other RATs, such as Wi-Fi UE 115-d. The first set of measurement resources 315-a include any number of resources and these resources may occur at any time. The first set of measurement resources may occur in a pre-configured pattern and may occur in a pre-configured periodicity. The number of resources and the timing of resources included in the first set of measurement resources 315-a may be pre-configured. Sidelink UEs 115 may be aware of the pre-configuration of the first set of measurement resources 315.

The second set of measurement resources 310-a may include resources where sidelink UEs 115 and wireless devices operating with other RATs, such as Wi-Fi UE 115-d are free to contend for resources and transmit signals. In some examples, the second set of measurement resources 310-a may include the first set of measurement resources 315-a. In some examples, the second set of measurement resources 310-a may exclude the first set of measurement resources 315-a. The second set of measurement resources 310-a may be configured as a sliding window of a fixed number of resources. The fixed number of resources could be any number of resources. For example, the second set of measurement resources 310-a may include the 100 slots immediately following the channel busy measurement. In another example, the second set of measurement resources 310-a may include the 100 slots immediately following the channel busy measurement excluding the first set of measurement resources.

In some examples, UE 115 may perform channel busy measurements on any resources in frequency band 305. For example, UE 115 may perform a first channel busy measurements at measurement slot 320-a on a first set of measurement resources 315-a and second channel busy measurement at measurement slot 320-a on a second set of measurement resources 310-a. Similarly, UE 115 may perform a first channel busy measurements at measurement slot 320-b on a first set of measurement resources 315-b and a second channel busy measurement at measurement slot 320-b on a second set of measurement resources 310-b. Alternatively, sidelink UEs 115 may be configured to perform channel busy measurements in defined resources.

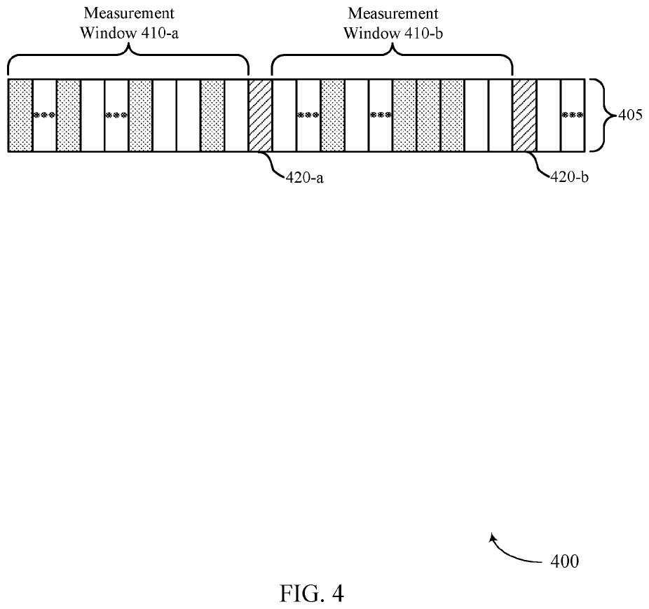

FIG. 4 illustrates an example of a wireless communication channel 400 that supports channel busy measurements in sidelink communications in accordance with aspects of the present disclosure. In some examples, wireless communication channel 400 may be an example of a communication channel implemented in aspects of wireless communications system 100 and wireless communications system 200. Wireless communication channel 400 may be on frequency band 405, which may be a frequency band in the unlicensed radio frequency spectrum. Sidelink UEs 115 may contend with other sidelink UEs 115 and Wi-Fi UEs 115 for resources on frequency band 405. Sidelink UEs 115 may perform congestion control to manage communication traffic on frequency band 405. Sidelink UEs 115 may perform channel busy measurement on frequency band 405 to inform congestion control functions in accordance with aspects of the present disclosure.

In some examples, a first UE 115 may monitor frequency band 405 to determine channel congestion in resources that other sidelink UEs 115 are using for communication. The first UE 115 may determine which resources other sidelink UEs 115 are using for communication by monitoring frequency band 405 for resources with contention-based access success. The first UE may determine resources with contention-based access success by monitoring resources in frequency band 405 for indication of SCI from other sidelink UEs 115 in coverage area 205. UE 115 may identify resources with contention-based access success in measurement window 410-a by determining which resources in measurement window 410-a contain indication of SCI. UE 115 may perform channel busy measurements on the resources with contention-based access success in measurement window 410.

The first UE 115 may perform channel busy measurements at measurement slot 420-a. UE 115 may perform channel busy measurement on the subset of resources with contention-based access success within measurement window 410-a based at least in part on the detection of indication of the contention-based access success.

In some examples, the channel busy measurement performed at measurement slot 420-a may be measured on the subset of resources within in measurement window 410-a. Measurement window 410-a may have a pre-configured length. For example, measurement window 410-a may be defined as the 100 slots proceeding measurement slot 420-a. In this example, the channel busy measurement performed at measurement slot 420-a may be measured on the resources within the subset of resources that are within the 100 slots proceeding measurement slot 420-a. Similarly, the channel busy measurement performed at measurement slot 420-b may be measured on subset of resources that are within the 100 slots proceeding measurement slot 420-b.

Alternatively, the first UE 115 may perform the channel busy measurements on a fixed number of resources within the subset of resources that proceed measurement slot 420-a. For example, a sidelink UE may perform channel busy measurements on the 100 slots within the subset of resources that proceed measurement slot 420-a. This method may estimate channel congestion over a fixed sample size.

The first UE 115 may perform channel busy measurements on any resources on frequency band 405. For example, UE 115 may perform a channel busy measurement at measurement slot 420-a based on the resources with contention-based access success within measurement window 410-a. Similarly, the first UE 115 may perform a channel busy measurement at measurement slot 420-b based on the resources with contention-based access success within measurement window 410-b. Alternatively, the first sidelink UEs 115 may be configured to perform channel busy measurements in defined resources.

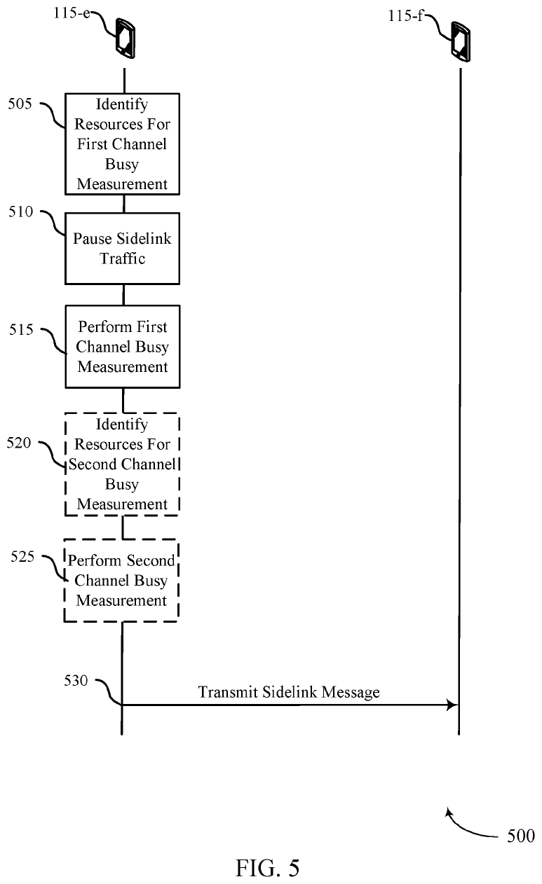

FIG. 5 illustrates an example of a process flow 500 that supports channel busy measurements in sidelink communications in accordance with aspects of the present disclosure. In some examples, process flow 500 may implement aspects of wireless communications system 100 and wireless communications system 200. UE 115-e and UE 115-f may be examples of UE 115 as described with reference to FIGS. 1 and 2. Process flow 500 illustrates an example of a process by which UE 115-e may transmit a message via sidelink communications to UE 115-f.

At 505, UE 115-e may identify a set of resources of an unlicensed radio frequency spectrum band that are configured for channel busy measurements that are free from sidelink traffic. UE 115-e may be configured with the set of resources that are free from sidelink traffic. UE 115-f may also be configured with the set of resources that are free from sidelink traffic.

At 510, UE 115-e may pause sidelink transmissions during the resource set identified at 505. UE 115-f may also pause sidelink transmission during the resource set identified at 505.

At 515, UE 115-e may perform a first channel busy measurement on the set of resources identified at 505. The first channel busy measurement may be performed by measuring one or more channel parameters over the set of resources determined at 505. The channel parameters may include, but are not limited to RSSI, RSRP, RSRQ, SINR.

At 520, UE 115-e may determine a second set of resources of the unlicensed radio frequency spectrum band where the second set of resources are configured for channel busy measurements that are associated with sidelink traffic. The second set of resource may be non-overlapping with the set of resources determined at 505.

At 525, UE 115-e may perform a second channel busy measurement for the second set of resources determined at 520. The channel busy measurement may be performed by measuring one or more channel parameters over the set of resources determined at 520. The channel parameters may include, but are not limited to RSSI, RSRP, RSRQ, SINR.

At 530, UE 115-e may communicate with UE 115-f via a channel of the unlicensed radio frequency spectrum band based at least in part on the channel busy measurement performed at 515. In some examples, UE 115-e may configure a set of communication parameters for sidelink communications based at least in part on the channel busy measurement determined at 515. In some examples, UE 115-e may configure a set of communication parameters for sidelink communications based at least in part on the channel busy measurement determined at 515 and the second channel busy measurement performed at 525. The set of communication parameters may include congestion control parameters. The congestion control parameters may include a modulation and coding scheme, a transmit power, a number of retransmissions, a number of sub-channels, a coding rate, or any combination thereof. In some examples, UE 115-e may select the channel of the unlicensed radio frequency spectrum band for communicating the UE 115-f based at least in part on determining that a congestion level of the channel satisfies a congestion control threshold. In some examples, UE 115-e may select the channel of the unlicensed radio frequency spectrum band for communicating a sidelink message with UE 115-f based at least in part on determining a priority of the sidelink message and further determining that the priority of the sidelink message satisfies a priority threshold. In some examples, UE 115-e may select the channel of the unlicensed radio frequency spectrum band for communicating with UE 115-f independent of a congestion level of the channel determine at 515.

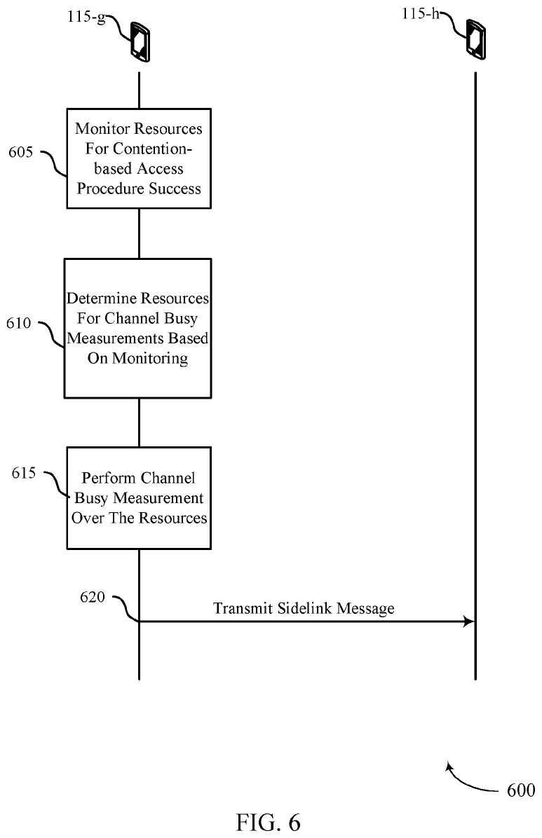

FIG. 6 illustrates an example of a process flow 600 that supports channel busy measurements in sidelink communications in accordance with aspects of the present disclosure. In some examples, process flow 600 may implement aspects of wireless communications system 100 and wireless communications system 200. UE 115-g and UE 115-h may be examples of UE 115 as described with reference to FIGS. 1 and 2. Process flow 600 illustrates an example of a process by which UE 115-g may transmit a message via sidelink communications to UE 115-h.

At 605, UE 115-g may monitor a resources of an unlicensed radio frequency spectrum band associated with sidelink communications. UE 115-g may monitor resources of the unlicensed radio frequency spectrum band to determine the congestion level on the frequency band. UE 115-g may determine the congestion level on the frequency band in order to perform congestion control. UE 115-g may perform congestion control by adjusting communication parameters associated with congestion control.

At 610, UE 115-g may determine resources for channel busy measurements, wherein each resource corresponds to a successful contention-based access procedure based at least in part on the monitoring at 605. UE 115-g may perform congestion control based on measuring congestion levels in resources that other sidelink UEs 115 in the coverage area are using for communications and omitting the congestion levels of resources dominated by other RATs. UE 115-g may determine the resources that sidelink UEs 115 are using for communication based on detection of indication of contention-based access success. UE 115-g may determine the resources with contention-based access success by detecting indication of SCI. UE 115-g may determine resources on which to perform channel busy measurements based on the detection of SCI.

At 615, UE 115-g may perform a channel busy measurement over the one or more resources determined at 610. The channel busy measurement may be performed by measuring one or more channel parameters over the set of resources determined at 610. The channel parameters may include, but are not limited to RSSI, RSRP, RSRQ, SINR.

At 620, UE 115-g may communicate with a UE 115-h via a channel of the unlicensed radio frequency spectrum band based at least in part on the channel busy measurement performed at 615. In some examples, UE 115-g may configure a set of communication parameters for sidelink communications based at least in part on the channel busy measurement performed at 615. The set of communication parameters may include congestion control parameters. The congestion control parameters may include a modulation and coding scheme, a transmit power, a number of retransmissions, a number of sub-channels, a coding rate, or any combination thereof. In some examples, UE 115-g may select the channel of the unlicensed radio frequency spectrum band for communicating to UE 115-h based at least in part on determining that a congestion level of the channel satisfies a congestion control threshold. In some examples, UE 115-g may select the channel of the unlicensed radio frequency spectrum band for communicating a sidelink message to UE 115-h based at least in part on determining a priority of the sidelink message and further determining that the priority of the sidelink message satisfies a priority threshold. In some examples, UE 115-g may select the channel of the unlicensed radio frequency spectrum band for communicating with UE 115-h independent of a congestion level of the channel determine at 615.

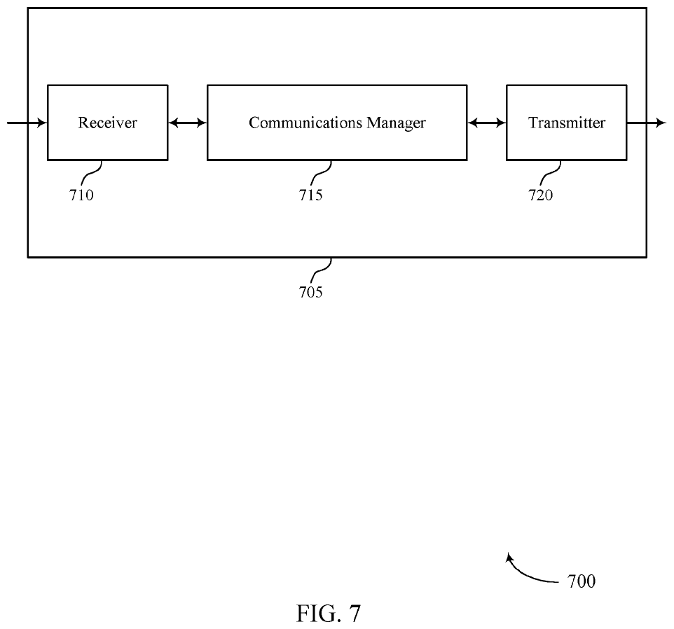

FIG. 7 shows a block diagram 700 of a device 705 that supports channel busy measurements in sidelink communications in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

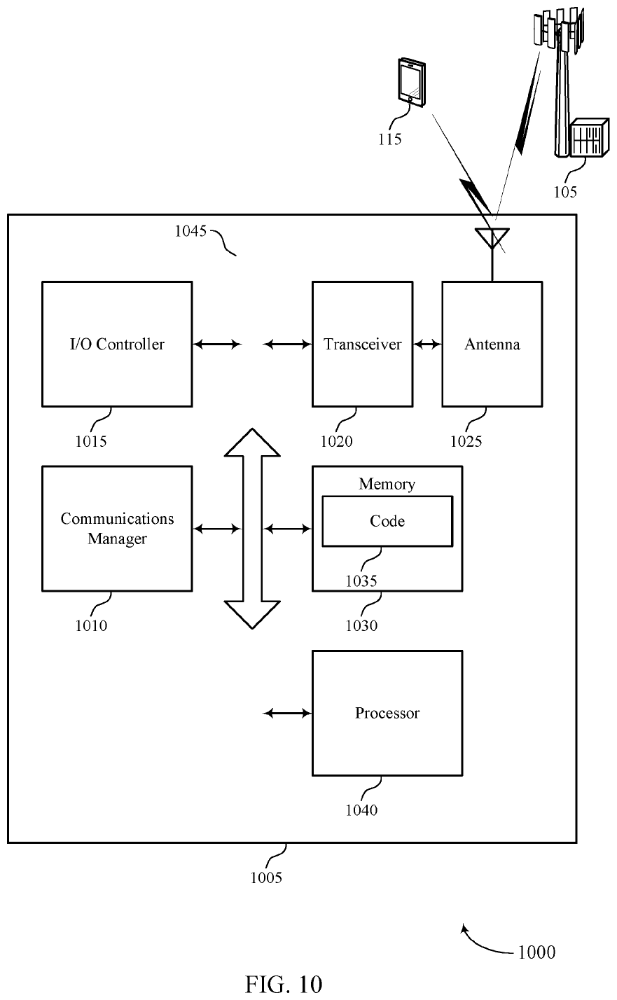

The receiver 710 may receive information such as packets, user data, or control information associated with various information channels (e.g., control channels, data channels, and information related to channel busy measurements in sidelink communications, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may identify a set of resources of an unlicensed radio frequency spectrum band, the set of resources configured for channel busy measurements that are free from sidelink traffic, pause sidelink transmissions during the identified resource set, perform, while pausing sidelink transmissions, a channel busy measurement for the set of resources, and communicate with a second UE via a channel of the unlicensed radio frequency spectrum band based on the channel busy measurement.

The communications manager 715 may also monitor each of a set of resources of an unlicensed radio frequency spectrum band associated with sidelink communications, determine one or more resources of the set of resources for channel busy measurements, where each of the one or more resources correspond to a successful contention-based access procedure based on the monitoring, perform a channel busy measurement for each of the one or more resources, and communicate with a second UE via a channel of the unlicensed radio frequency spectrum band based on the channel busy measurement. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

In some examples, the communications manager 715 may be implemented as an integrated circuit or chipset for a mobile device modem, and the receiver 710 and transmitter 720 may be implemented as analog components (e.g., amplifiers, filters, antennas) coupled with the mobile device modem to enable wireless transmission and reception over one or more bands.

The communications manager 715 as described herein may be implemented to realize one or more potential advantages. One implementation may allow the device 705 to more accurately measure channels for sidelink communications. The communications manager 715 may use the techniques described herein to determine sidelink resource sets and perform channel busy measurements to determine whether a sidelink channel may be used for sidelink transmissions.

As such, the device 705 may more accurately determine congestion on sidelink channels prior to transmitting sidelink messages, which may enable to UE to transmit sidelink messages with increased reliability and, accordingly, may communicate over the channel with a greater likelihood of successful communications. In some examples, based on a greater likelihood of successful communications, the device 705 may more efficiently power a processor or one or more processing units associated with transmitting and receiving sidelink communications, which may enable the device to save power and increase battery life.

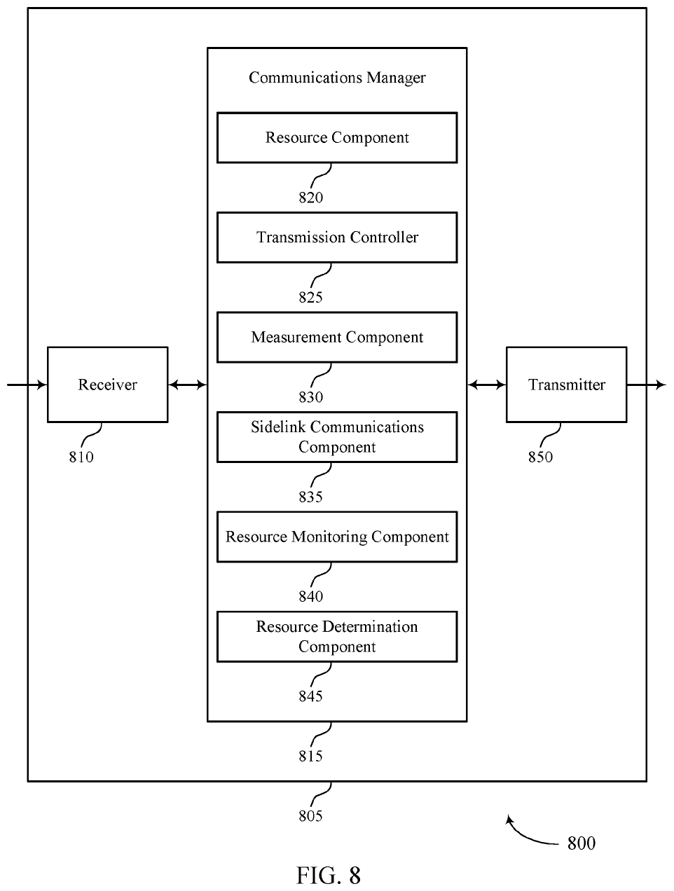

FIG. 8 shows a block diagram 800 of a device 805 that supports channel busy measurements in sidelink communications in accordance with aspects of the present disclosure. The device 805 may be an example of aspects of a device 705, or a UE 115 as described herein. The device 805 may include a receiver 810, a communications manager 815, and a transmitter 850. The device 805 may also include a processor. Each of these components may be in communication with one another (e.g., via one or more buses).

The receiver 810 may receive information such as packets, user data, or control information associated with various information channels (e.g., control channels, data channels, and information related to channel busy measurements in sidelink communications, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a resource component 820, a transmission controller 825, a measurement component 830, a sidelink communications component 835, a resource monitoring component 840, and a resource determination component 845. The communications manager 815 may be an example of aspects of the communications manager 1010 described herein.

The resource component 820 may identify a set of resources of an unlicensed radio frequency spectrum band, the set of resources configured for channel busy measurements that are free from sidelink traffic.

The transmission controller 825 may pause sidelink transmissions during the identified resource set.

The measurement component 830 may perform, while pausing sidelink transmissions, a channel busy measurement for the set of resources.

The sidelink communications component 835 may communicate with a second UE via a channel of the unlicensed radio frequency spectrum band based on the channel busy measurement.

The resource monitoring component 840 may monitor each of a set of resources of an unlicensed radio frequency spectrum band associated with sidelink communications.

The resource determination component 845 may determine one or more resources of the set of resources for channel busy measurements, where each of the one or more resources correspond to a successful contention-based access procedure based on the monitoring.

The measurement component 830 may perform a channel busy measurement for each of the one or more resources.

The sidelink communications component 835 may communicate with a second UE via a channel of the unlicensed radio frequency spectrum band based on the channel busy measurement.

The transmitter 850 may transmit signals generated by other components of the device 805. In some examples, the transmitter 850 may be collocated with a receiver 810 in a transceiver module. For example, the transmitter 850 may be an example of aspects of the transceiver 1020 described with reference to FIG. 10. The transmitter 850 may utilize a single antenna or a set of antennas.

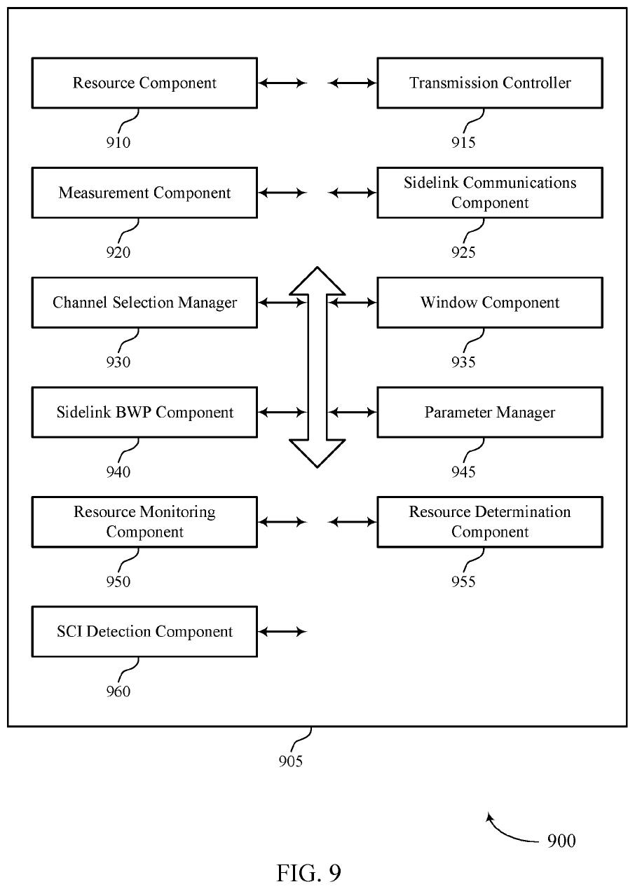

FIG. 9 shows a block diagram 900 of a communications manager 905 that supports channel busy measurements in sidelink communications in accordance with aspects of the present disclosure. The communications manager 905 may be an example of aspects of a communications manager 715, a communications manager 815, or a communications manager 1010 described herein. The communications manager 905 may include a resource component 910, a transmission controller 915, a measurement component 920, a sidelink communications component 925, a channel selection manager 930, a window component 935, a sidelink BWP component 940, a parameter manager 945, a resource monitoring component 950, a resource determination component 955, and a SCI detection component 960. Each of these modules may communicate, directly or indirectly, with one another (e.g., via one or more buses).

The resource component 910 may identify a set of resources of an unlicensed radio frequency spectrum band, the set of resources configured for channel busy measurements that are free from sidelink traffic. In some examples, the resource component 910 may determine a second set of resources of the unlicensed radio frequency spectrum band, the second set of resources configured for channel busy measurements that are associated with sidelink traffic.

The transmission controller 915 may pause sidelink transmissions during the identified resource set.

The measurement component 920 may perform, while pausing sidelink transmissions, a channel busy measurement for the set of resources. In some examples, the measurement component 920 may perform a channel busy measurement for each of the one or more resources. In some examples, the measurement component 920 may measure one or more channel parameters over the measurement window and the set of resources. In some examples, the measurement component 920 may perform the channel busy measurement on at least one subcarrier excluded from the active bandwidth part. In some examples, the measurement component 920 may perform a second channel busy measurement for the second set of resources.

In some examples, the measurement component 920 may perform the second channel busy measurement on resources of the second set of resources that are non-overlapping with the set of resources. In some cases, the one or more channel parameters include RSSI, RSRP, RSRQ, SINR, or any combination thereof.

The sidelink communications component 925 may communicate with a second UE via a channel of the unlicensed radio frequency spectrum band based on the channel busy measurement. In some examples, the sidelink communications component 925 may communicate with a second UE via a channel of the unlicensed radio frequency spectrum band based on the channel busy measurement. In some examples, the sidelink communications component 925 may communicate with the second UE using the set of communication parameters.

The resource monitoring component 950 may monitor each of a set of resources of an unlicensed radio frequency spectrum band associated with sidelink communications.

The resource determination component 955 may determine one or more resources of the set of resources for channel busy measurements, where each of the one or more resources correspond to a successful contention-based access procedure based on the monitoring. In some examples, the resource determination component 955 may perform channel sensing in each of the set of resources based at least in part on the monitoring, where the one or more resources of the plurality of resources are determined based on successful channel sensing.

The channel selection manager 930 may select the channel of the unlicensed radio frequency spectrum band for communicating with the second UE based on determining that a congestion level of the channel satisfies a congestion threshold. In some examples, the channel selection manager 930 may select the channel of the unlicensed radio frequency spectrum band for communicating a sidelink message with the second UE based on determining that a priority of the sidelink message satisfies a priority threshold. In some examples, the channel selection manager 930 may select the channel of the unlicensed radio frequency spectrum band for communicating with the second UE independent of a congestion level of the channel satisfying a congestion threshold.

In some examples, the channel selection manager 930 may select the channel of the unlicensed radio frequency spectrum band for communicating with the second UE based on the second channel busy measurement. In some cases, the priority threshold corresponds to a service type of the sidelink message.

The window component 935 may determine a measurement window configured for measurements that are free from sidelink traffic. In some examples, the window component 935 may determine a window that spans the set of resources of the unlicensed radio frequency spectrum band associated with sidelink communications, where the channel busy measurement is performed for each of the one or more resources within the window. In some cases, the window corresponds to a number of the set of resources. In some cases, the window corresponds to a number of the one or more resources.

The sidelink BWP component 940 may determine an active bandwidth part for sidelink communications between the UE and the second UE.

The parameter manager 945 may determine a set of communication parameters for sidelink communications based on the channel busy measurement and the second channel busy measurement. In some examples, the parameter manager 945 may determine a difference between the channel busy measurement and the second channel busy measurement. In some examples, the parameter manager 945 may select the set of communication parameters based on the difference. In some cases, the set of communication parameters includes an MCS, a transmit power, a number of retransmissions, a number of sub-channels, a coding rate, or any combination thereof.

The SCI detection component 960 may detect sidelink control information in each of the one or more resources based on the monitoring, where the one or more resources of the set of resources are determined based on detecting the sidelink control information. In some cases, the sidelink control information is associated with a transmitting UE different from the first UE.

FIG. 10 shows a diagram of a system 1000 including a device 1005 that supports channel busy measurements in sidelink communications in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may identify a set of resources of an unlicensed radio frequency spectrum band, the set of resources configured for channel busy measurements that are free from sidelink traffic, pause sidelink transmissions during the identified resource set, perform, while pausing sidelink transmissions, a channel busy measurement for the set of resources, and communicate with a second UE via a channel of the unlicensed radio frequency spectrum band based on the channel busy measurement.

The communications manager 1010 may also monitor each of a set of resources of an unlicensed radio frequency spectrum band associated with sidelink communications, determine one or more resources of the set of resources for channel busy measurements, where each of the one or more resources correspond to a successful contention-based access procedure based on the monitoring, perform a channel busy measurement for each of the one or more resources, and communicate with a second UE via a channel of the unlicensed radio frequency spectrum band based on the channel busy measurement.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the device 1005 may include a single antenna 1025, or the device 1005 may have more than one antenna 1025, which may be capable of concurrently transmitting or receiving multiple wireless transmissions.

The memory 1030 may include random access memory (RAM) and read only memory (ROM). The memory 1030 may store computer-readable, computer-executable code 1035 including instructions that, when executed, cause the processor to perform various functions described herein. In some cases, the memory 1030 may contain, among other things, a basic I/O system (BIOS) which may control basic hardware or software operation such as the interaction with peripheral components or devices.

The processor 1040 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting channel busy measurements in sidelink communications).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

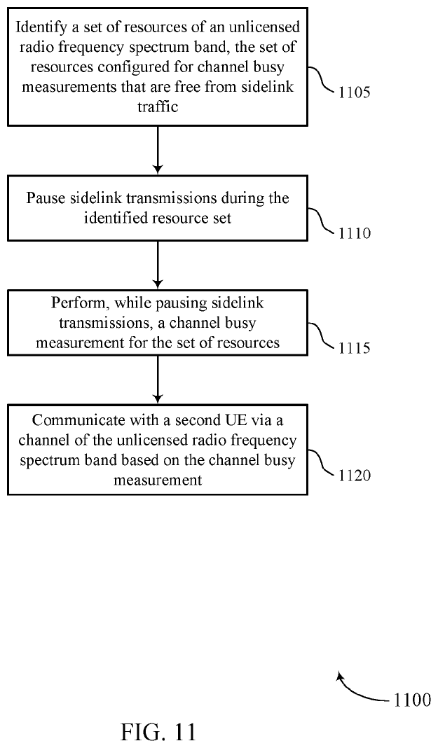

FIG. 11 shows a flowchart illustrating a method 1100 that supports channel busy measurements in sidelink communications in accordance with aspects of the present disclosure. The operations of method 1100 may be implemented by a UE 115 or its components as described herein. For example, the operations of method 1100 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1105, the UE may identify a set of resources of an unlicensed radio frequency spectrum band, the set of resources configured for channel busy measurements that are free from sidelink traffic. The operations of 1105 may be performed according to the methods described herein. In some examples, aspects of the operations of 1105 may be performed by a resource component as described with reference to FIGS. 7 through 10.

At 1110, the UE may pause sidelink transmissions during the identified resource set. The operations of 1110 may be performed according to the methods described herein. In some examples, aspects of the operations of 1110 may be performed by a transmission controller as described with reference to FIGS. 7 through 10.

At 1115, the UE may perform, while pausing sidelink transmissions, a channel busy measurement for the set of resources. The operations of 1115 may be performed according to the methods described herein. In some examples, aspects of the operations of 1115 may be performed by a measurement component as described with reference to FIGS. 7 through 10.

At 1120, the UE may communicate with a second UE via a channel of the unlicensed radio frequency spectrum band based on the channel busy measurement. The operations of 1120 may be performed according to the methods described herein. In some examples, aspects of the operations of 1120 may be performed by a sidelink communications component as described with reference to FIGS. 7 through 10.

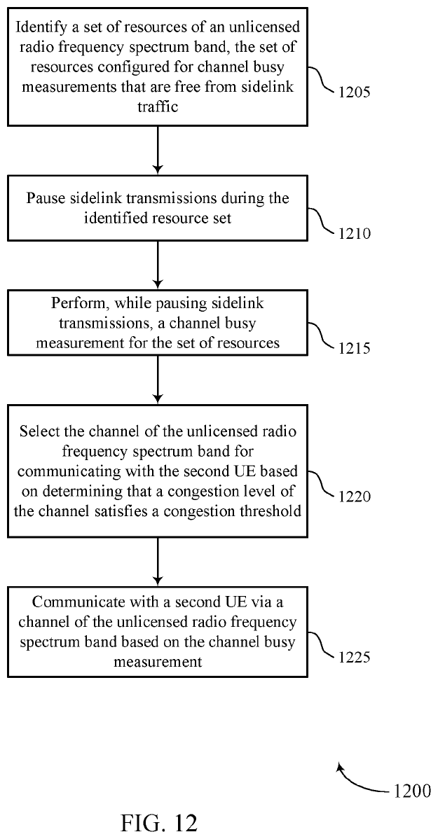

FIG. 12 shows a flowchart illustrating a method 1200 that supports channel busy measurements in sidelink communications in accordance with aspects of the present disclosure. The operations of method 1200 may be implemented by a UE 115 or its components as described herein. For example, the operations of method 1200 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1205, the UE may identify a set of resources of an unlicensed radio frequency spectrum band, the set of resources configured for channel busy measurements that are free from sidelink traffic. The operations of 1205 may be performed according to the methods described herein. In some examples, aspects of the operations of 1205 may be performed by a resource component as described with reference to FIGS. 7 through 10.

At 1210, the UE may pause sidelink transmissions during the identified resource set. The operations of 1210 may be performed according to the methods described herein. In some examples, aspects of the operations of 1210 may be performed by a transmission controller as described with reference to FIGS. 7 through 10.

At 1215, the UE may perform, while pausing sidelink transmissions, a channel busy measurement for the set of resources. The operations of 1215 may be performed according to the methods described herein. In some examples, aspects of the operations of 1215 may be performed by a measurement component as described with reference to FIGS. 7 through 10.

At 1220, the UE may select the channel of the unlicensed radio frequency spectrum band for communicating with the second UE based on determining that a congestion level of the channel satisfies a congestion threshold. The operations of 1220 may be performed according to the methods described herein. In some examples, aspects of the operations of 1220 may be performed by a channel selection manager as described with reference to FIGS. 7 through 10.

At 1225, the UE may communicate with a second UE via a channel of the unlicensed radio frequency spectrum band based on the channel busy measurement. The operations of 1225 may be performed according to the methods described herein. In some examples, aspects of the operations of 1225 may be performed by a sidelink communications component as described with reference to FIGS. 7 through 10.

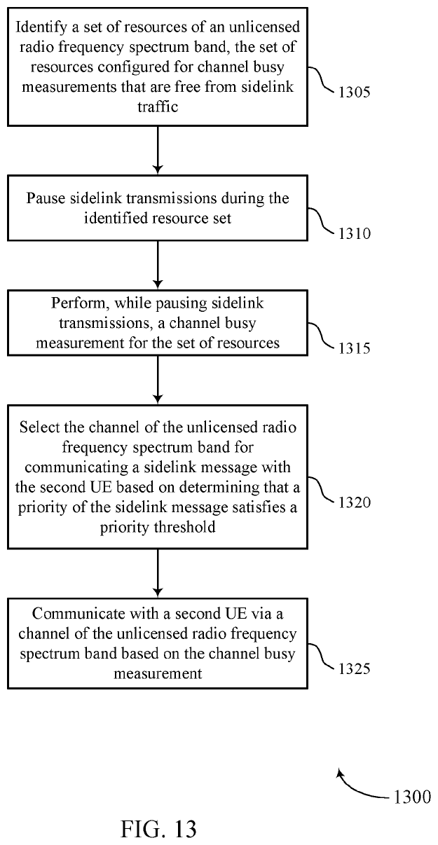

FIG. 13 shows a flowchart illustrating a method 1300 that supports channel busy measurements in sidelink communications in accordance with aspects of the present disclosure. The operations of method 1300 may be implemented by a UE 115 or its components as described herein. For example, the operations of method 1300 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1305, the UE may identify a set of resources of an unlicensed radio frequency spectrum band, the set of resources configured for channel busy measurements that are free from sidelink traffic. The operations of 1305 may be performed according to the methods described herein. In some examples, aspects of the operations of 1305 may be performed by a resource component as described with reference to FIGS. 7 through 10.

At 1310, the UE may pause sidelink transmissions during the identified resource set. The operations of 1310 may be performed according to the methods described herein. In some examples, aspects of the operations of 1310 may be performed by a transmission controller as described with reference to FIGS. 7 through 10.

At 1315, the UE may perform, while pausing sidelink transmissions, a channel busy measurement for the set of resources. The operations of 1315 may be performed according to the methods described herein. In some examples, aspects of the operations of 1315 may be performed by a measurement component as described with reference to FIGS. 7 through 10.

At 1320, the UE may select the channel of the unlicensed radio frequency spectrum band for communicating a sidelink message with the second UE based on determining that a priority of the sidelink message satisfies a priority threshold. The operations of 1320 may be performed according to the methods described herein. In some examples, aspects of the operations of 1320 may be performed by a channel selection manager as described with reference to FIGS. 7 through 10.

At 1325, the UE may communicate with a second UE via a channel of the unlicensed radio frequency spectrum band based on the channel busy measurement. The operations of 1325 may be performed according to the methods described herein. In some examples, aspects of the operations of 1325 may be performed by a sidelink communications component as described with reference to FIGS. 7 through 10.

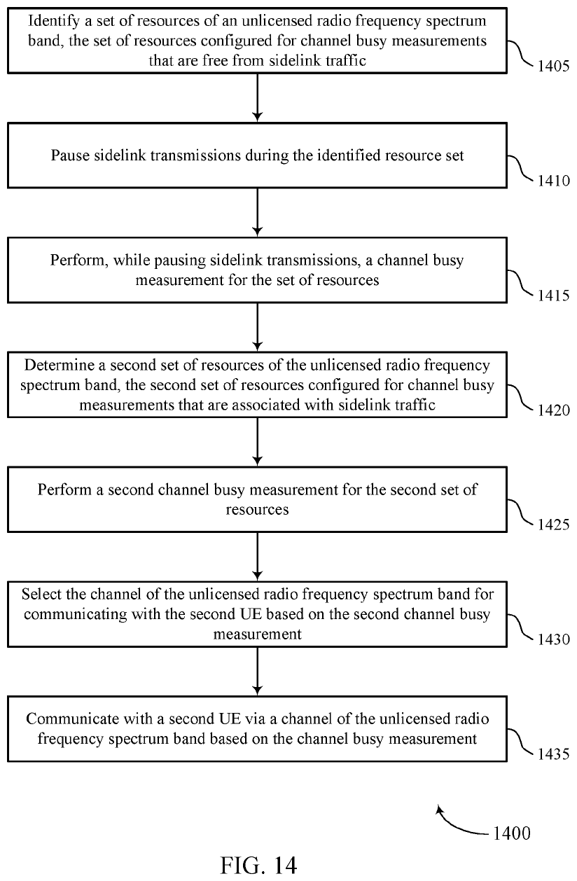

FIG. 14 shows a flowchart illustrating a method 1400 that supports channel busy measurements in sidelink communications in accordance with aspects of the present disclosure. The operations of method 1400 may be implemented by a UE 115 or its components as described herein. For example, the operations of method 1400 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1405, the UE may identify a set of resources of an unlicensed radio frequency spectrum band, the set of resources configured for channel busy measurements that are free from sidelink traffic. The operations of 1405 may be performed according to the methods described herein. In some examples, aspects of the operations of 1405 may be performed by a resource component as described with reference to FIGS. 7 through 10.

At 1410, the UE may pause sidelink transmissions during the identified resource set. The operations of 1410 may be performed according to the methods described herein. In some examples, aspects of the operations of 1410 may be performed by a transmission controller as described with reference to FIGS. 7 through 10.

At 1415, the UE may perform, while pausing sidelink transmissions, a channel busy measurement for the set of resources. The operations of 1415 may be performed according to the methods described herein. In some examples, aspects of the operations of 1415 may be performed by a measurement component as described with reference to FIGS. 7 through 10.

At 1420, the UE may determine a second set of resources of the unlicensed radio frequency spectrum band, the second set of resources configured for channel busy measurements that are associated with sidelink traffic. The operations of 1420 may be performed according to the methods described herein. In some examples, aspects of the operations of 1420 may be performed by a resource component as described with reference to FIGS. 7 through 10.

At 1425, the UE may perform a second channel busy measurement for the second set of resources. The operations of 1425 may be performed according to the methods described herein. In some examples, aspects of the operations of 1425 may be performed by a measurement component as described with reference to FIGS. 7 through 10.

At 1430, the UE may select the channel of the unlicensed radio frequency spectrum band for communicating with the second UE based on the second channel busy measurement. The operations of 1430 may be performed according to the methods described herein. In some examples, aspects of the operations of 1430 may be performed by a channel selection manager as described with reference to FIGS. 7 through 10.

At 1435, the UE may communicate with a second UE via a channel of the unlicensed radio frequency spectrum band based on the channel busy measurement. The operations of 1435 may be performed according to the methods described herein. In some examples, aspects of the operations of 1435 may be performed by a sidelink communications component as described with reference to FIGS. 7 through 10.

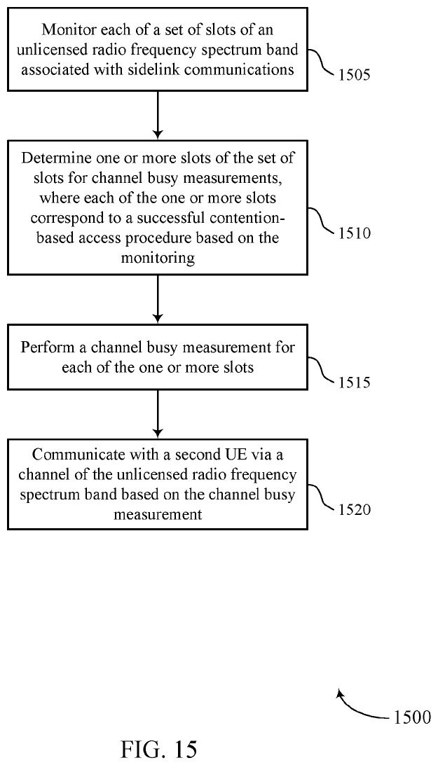

FIG. 15 shows a flowchart illustrating a method 1500 that supports channel busy measurements in sidelink communications in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1505, the UE may monitor each of a set of resources of an unlicensed radio frequency spectrum band associated with sidelink communications. The operations of 1505 may be performed according to the methods described herein. In some examples, aspects of the operations of 1505 may be performed by a resource monitoring component as described with reference to FIGS. 7 through 10.

At 1510, the UE may determine one or more resources of the set of resources for channel busy measurements, where each of the one or more resources correspond to a successful contention-based access procedure based on the monitoring. The operations of 1510 may be performed according to the methods described herein. In some examples, aspects of the operations of 1510 may be performed by a resource determination component as described with reference to FIGS. 7 through 10.

At 1515, the UE may perform a channel busy measurement for each of the one or more resources. The operations of 1515 may be performed according to the methods described herein. In some examples, aspects of the operations of 1515 may be performed by a measurement component as described with reference to FIGS. 7 through 10.

At 1520, the UE may communicate with a second UE via a channel of the unlicensed radio frequency spectrum band based on the channel busy measurement. The operations of 1520 may be performed according to the methods described herein. In some examples, aspects of the operations of 1520 may be performed by a sidelink communications component as described with reference to FIGS. 7 through 10.

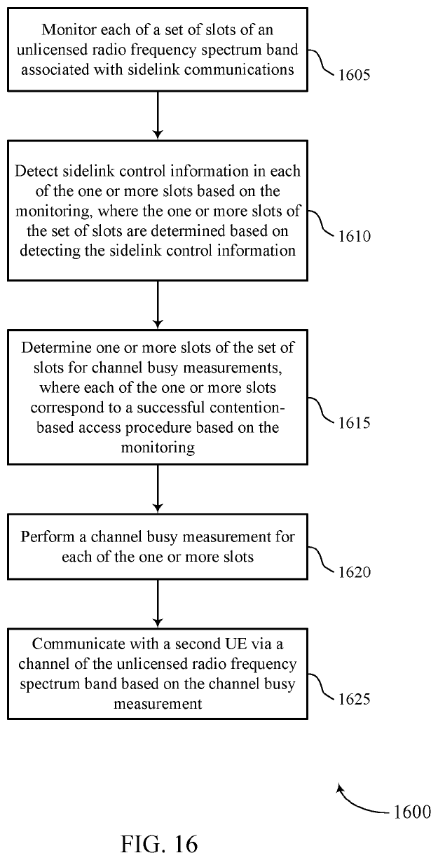

FIG. 16 shows a flowchart illustrating a method 1600 that supports channel busy measurements in sidelink communications in accordance with aspects of the present disclosure. The operations of method 1600 may be implemented by a UE 115 or its components as described herein. For example, the operations of method 1600 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1605, the UE may monitor each of a set of resources of an unlicensed radio frequency spectrum band associated with sidelink communications. The operations of 1605 may be performed according to the methods described herein. In some examples, aspects of the operations of 1605 may be performed by a resource monitoring component as described with reference to FIGS. 7 through 10.

At 1610, the UE may detect sidelink control information in each of the one or more resources based on the monitoring, where the one or more resources of the set of resources are determined based on detecting the sidelink control information. The operations of 1610 may be performed according to the methods described herein. In some examples, aspects of the operations of 1610 may be performed by a SCI detection component as described with reference to FIGS. 7 through 10.

At 1615, the UE may determine one or more resources of the set of resources for channel busy measurements, where each of the one or more resources correspond to a successful contention-based access procedure based on the monitoring. The operations of 1615 may be performed according to the methods described herein. In some examples, aspects of the operations of 1615 may be performed by a resource determination component as described with reference to FIGS. 7 through 10.

At 1620, the UE may perform a channel busy measurement for each of the one or more resources. The operations of 1620 may be performed according to the methods described herein. In some examples, aspects of the operations of 1620 may be performed by a measurement component as described with reference to FIGS. 7 through 10.

At 1625, the UE may communicate with a second UE via a channel of the unlicensed radio frequency spectrum band based on the channel busy measurement. The operations of 1625 may be performed according to the methods described herein. In some examples, aspects of the operations of 1625 may be performed by a sidelink communications component as described with reference to FIGS. 7 through 10.

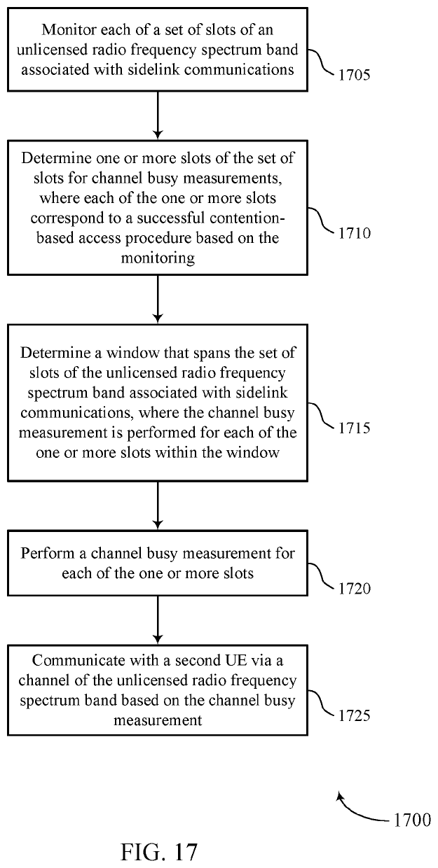

FIG. 17 shows a flowchart illustrating a method 1700 that supports channel busy measurements in sidelink communications in accordance with aspects of the present disclosure. The operations of method 1700 may be implemented by a UE 115 or its components as described herein. For example, the operations of method 1700 may be performed by a communications manager as described with reference to FIGS. 7 through 10. In some examples, a UE may execute a set of instructions to control the functional elements of the UE to perform the functions described herein. Additionally or alternatively, a UE may perform aspects of the functions described herein using special-purpose hardware.

At 1705, the UE may monitor each of a set of resources of an unlicensed radio frequency spectrum band associated with sidelink communications. The operations of 1705 may be performed according to the methods described herein. In some examples, aspects of the operations of 1705 may be performed by a resource monitoring component as described with reference to FIGS. 7 through 10.

At 1710, the UE may determine one or more resources of the set of resources for channel busy measurements, where each of the one or more resources correspond to a successful contention-based access procedure based on the monitoring. The operations of 1710 may be performed according to the methods described herein. In some examples, aspects of the operations of 1710 may be performed by a resource determination component as described with reference to FIGS. 7 through 10.

At 1715, the UE may determine a window that spans the set of resources of the unlicensed radio frequency spectrum band associated with sidelink communications, where the channel busy measurement is performed for each of the one or more resources within the window. The operations of 1715 may be performed according to the methods described herein. In some examples, aspects of the operations of 1715 may be performed by a window component as described with reference to FIGS. 7 through 10.

At 1720, the UE may perform a channel busy measurement for each of the one or more resources. The operations of 1720 may be performed according to the methods described herein. In some examples, aspects of the operations of 1720 may be performed by a measurement component as described with reference to FIGS. 7 through 10.

At 1725, the UE may communicate with a second UE via a channel of the unlicensed radio frequency spectrum band based on the channel busy measurement. The operations of 1725 may be performed according to the methods described herein. In some examples, aspects of the operations of 1725 may be performed by a sidelink communications component as described with reference to FIGS. 7 through 10.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a first user equipment (UE), comprising:
identifying a set of resources of an unlicensed radio frequency spectrum band, the set of resources configured for channel busy measurements that are free from sidelink traffic;
pausing sidelink transmissions during the identified resource set;
performing, while pausing sidelink transmissions, a channel busy measurement for the set of resources; and
communicating with a second UE via a channel of the unlicensed radio frequency spectrum band based at least in part on the channel busy measurement.

2. The method of claim 1, further comprising:
selecting the channel of the unlicensed radio frequency spectrum band for communicating with the second UE based at least in part on determining that a congestion level of the channel satisfies a congestion threshold.

3. The method of claim 1, further comprising:
selecting the channel of the unlicensed radio frequency spectrum band for communicating a sidelink message with the second UE based at least in part on determining that a priority of the sidelink message satisfies a priority threshold.

4. The method of claim 3, further comprising:
selecting the channel of the unlicensed radio frequency spectrum band for communicating with the second UE independent of a congestion level of the channel satisfying a congestion threshold.

5. The method of claim 3, wherein the priority threshold corresponds to a service type of the sidelink message.

6. The method of claim 1, wherein performing the channel busy measurement comprises:
determining a measurement window configured for measurements that are free from sidelink traffic; and
measuring one or more channel parameters over the measurement window and the set of resources.

7. The method of claim 6, wherein the one or more channel parameters comprise received signal strength indicator (RSSI), reference signal received power (RSRP), reference signal received quality (RSRQ), signal to interference plus noise ratio (SINR), or any combination thereof.

8. The method of claim 1, further comprising:
determining an active bandwidth part for sidelink communications between the UE and the second UE; and
performing the channel busy measurement on at least one subcarrier excluded from the active bandwidth part.

9. The method of claim 1, further comprising:
determining a second set of resources of the unlicensed radio frequency spectrum band, the second set of resources configured for channel busy measurements that are associated with sidelink traffic;
performing a second channel busy measurement for the second set of resources; and
selecting the channel of the unlicensed radio frequency spectrum band for communicating with the second UE based at least in part on the second channel busy measurement.

10. The method of claim 9, wherein performing the second channel busy measurement comprises:
performing the second channel busy measurement on resources of the second set of resources that are non-overlapping with the set of resources.

11-13. (canceled)

14. A method for wireless communications at a first user equipment (UE), comprising:
monitoring each of a plurality of resources of an unlicensed radio frequency spectrum band associated with sidelink communications;
performing a channel busy measurement for each of one or more resources for channel busy measurements, the one or more resources of the plurality of resources, wherein each of the one or more resources corresponds to a successful contention-based access procedure based at least in part on the monitoring; and
communicating with a second UE via a channel of the unlicensed radio frequency spectrum band based at least in part on the channel busy measurement.

15. The method of claim 14, further comprising:
detecting sidelink control information in each of the one or more resources based at least in part on the monitoring, wherein the one or more resources of the plurality of resources are determined based at least in part on detecting the sidelink control information.

16. The method of claim 15, wherein the sidelink control information is associated with a transmitting UE different from the first UE.

17. The method of claim 14, further comprising:
determining a window that spans the plurality of resources of the unlicensed radio frequency spectrum band associated with sidelink communications, wherein the channel busy measurement is performed for each of the one or more resources within the window.

18-20. (canceled)

21. An apparatus for wireless communications at a first user equipment (UE), comprising:
a processor,
memory coupled with the processor; and
instructions stored in the memory and executable by the processor to cause the apparatus to:
identify a set of resources of an unlicensed radio frequency spectrum band, the set of resources configured for channel busy measurements that are free from sidelink traffic;
pause sidelink transmissions during the identified resource set;
perform, while pausing sidelink transmissions, a channel busy measurement for the set of resources; and
communicate with a second UE via a channel of the unlicensed radio frequency spectrum band based at least in part on the channel busy measurement.

22. The apparatus of claim 21, wherein the instructions are further executable by the processor to cause the apparatus to:
select the channel of the unlicensed radio frequency spectrum band for communicating with the second UE based at least in part on determining that a congestion level of the channel satisfies a congestion threshold.

23. The apparatus of claim 21, wherein the instructions are further executable by the processor to cause the apparatus to:
select the channel of the unlicensed radio frequency spectrum band for communicating a sidelink message with the second UE based at least in part on determining that a priority of the sidelink message satisfies a priority threshold.

24. The apparatus of claim 23, wherein the instructions are further executable by the processor to cause the apparatus to:
select the channel of the unlicensed radio frequency spectrum band for communicating with the second UE independent of a congestion level of the channel satisfying a congestion threshold.

25. The apparatus of claim 23, wherein the priority threshold corresponds to a service type of the sidelink message.

26. The apparatus of claim 21, wherein the instructions to perform the channel busy measurement are executable by the processor to cause the apparatus to:
determine a measurement window configured for measurements that are free from sidelink traffic; and
measure one or more channel parameters over the measurement window and the set of resources.

27. The apparatus of claim 26, wherein the one or more channel parameters comprise received signal strength indicator (RSSI), reference signal received power (RSRP), reference signal received quality (RSRQ), signal to interference plus noise ratio (SINR), or any combination thereof.

28. The apparatus of claim 21, wherein the instructions are further executable by the processor to cause the apparatus to:
determine an active bandwidth part for sidelink communications between the UE and the second UE; and
perform the channel busy measurement on at least one subcarrier excluded from the active bandwidth part.

29. The apparatus of claim 21, wherein the instructions are further executable by the processor to cause the apparatus to:
determine a second set of resources of the unlicensed radio frequency spectrum band, the second set of resources configured for channel busy measurements that are associated with sidelink traffic;
perform a second channel busy measurement for the second set of resources; and
select the channel of the unlicensed radio frequency spectrum band for communicating with the second UE based at least in part on the second channel busy measurement.

30. The apparatus of claim 29, wherein the instructions to perform the second channel busy measurement are executable by the processor to cause the apparatus to:
perform the second channel busy measurement on resources of the second set of resources that are non-overlapping with the set of resources.

31. The apparatus of claim 29, wherein the instructions are further executable by the processor to cause the apparatus to:
determine a set of communication parameters for sidelink communications based at least in part on the channel busy measurement and the second channel busy measurement; and
communicate with the second UE using the set of communication parameters.

32. The apparatus of claim 31, wherein the instructions to determine the set of communication parameters are executable by the processor to cause the apparatus to:
determine a difference between the channel busy measurement and the second channel busy measurement; and
select the set of communication parameters based at least in part on the difference.

33. The apparatus of claim 31, wherein the set of communication parameters comprises a modulation and coding scheme (MCS), a transmit power, a number of retransmissions, a number of sub-channels, a coding rate, or any combination thereof.

34. An apparatus for wireless communications at a first user equipment (UE), comprising:
a processor,
memory coupled with the processor; and
instructions stored in the memory and executable by the processor to cause the apparatus to:
monitor each of a plurality of resources of an unlicensed radio frequency spectrum band associated with sidelink communications;
perform a channel busy measurement for each of one or more resources for channel busy measurements, the one or more resources of the plurality of resources, wherein each of the one or more resources corresponds to a successful contention-based access procedure based at least in part on the monitoring; and
communicate with a second UE via a channel of the unlicensed radio frequency spectrum band based at least in part on the channel busy measurement.

35. The apparatus of claim 34, wherein the instructions are further executable by the processor to cause the apparatus to:
detect sidelink control information in each of the one or more resources based at least in part on the monitoring, wherein the one or more resources of the plurality of resources are determined based at least in part on detecting the sidelink control information.

36. The apparatus of claim 35, wherein the sidelink control information is associated with a transmitting UE different from the first UE.

37. The apparatus of claim 34, wherein the instructions are further executable by the processor to cause the apparatus to:
determine a window that spans the plurality of resources of the unlicensed radio frequency spectrum band associated with sidelink communications, wherein the channel busy measurement is performed for each of the one or more resources within the window.

38. The apparatus of claim 37, wherein the window corresponds to a number of the plurality of resources.

39. The apparatus of claim 37, wherein the window corresponds to a number of the one or more resources.

40. The apparatus of claim 34, wherein the instructions are further executable by the processor to cause the apparatus to:
perform channel sensing in each of the plurality of resources based at least in part on the monitoring, wherein the one or more resources of the plurality of resources are determined based at least in part on successful channel sensing.

41. An apparatus for wireless communications at a first user equipment (UE), comprising:
means for identifying a set of resources of an unlicensed radio frequency spectrum band, the set of resources configured for channel busy measurements that are free from sidelink traffic;
means for pausing sidelink transmissions during the identified resource set;
means for performing, while pausing sidelink transmissions, a channel busy measurement for the set of resources; and
means for communicating with a second UE via a channel of the unlicensed radio frequency spectrum band based at least in part on the channel busy measurement.

42-80. (canceled)
